(19) United States
(12) Patent Application Publication
(10) Pub. No.: US 2025/0124137 A1
(43) Pub. Date: Apr. 17, 2025

(54) AUTOMATED VULNERABILITY MANAGEMENT SYSTEM

(71) Applicant: Omnissa, LLC, Mountain View, CA (US)

(72) Inventors: Aaron Greer Black, Leawood, KS (US); Paul Burton Evans, Roswell, GA (US); Krishnanunni Sadasivan Pillai, Canton, GA (US); Benjamin Luke Tedesco, Cornelius, NC (US); Aditya Shrotri, San Jose, CA (US)

(21) Appl. No.: 18/488,501

(22) Filed: Oct. 17, 2023

(51) Int. Cl. G06F 21/57; G06F 8/65; G06F 8/71; G06F 16/2455

(52) U.S. Cl. CPC G06F 21/577; G06F 8/65; G06F 8/71; G06F 16/2455; G06F 2221/033

(57) ABSTRACT

Disclosed are various embodiments for automated vulnerability management. In some embodiments, a list of available updates from a device management system is collected. Then, the device management system is queried to obtain device information to determining applicable updates for operating systems, applications, and firmware based on the list of available updates. Next, a common platform enumeration (CPE) is determined for the updates in the list of available updates and the current version of the operating systems, applications, firmware. Next, a reverse lookup is performed in a vulnerability database for vulnerabilities. The vulnerabilities of the current version of the operating systems, applications, firmware are compared with the vulnerabilities of the updates in the list of available updates. Finally, a vulnerability report is generated.

### BACKGROUND

In an enterprise, electronic devices run various systems (e.g., Microsoft Windows, Mac OS X, Linux, etc.), various firmware, applications, etc. Typically, the device management systems have provided a means to collect and distribute updates to devices, but the process of determining which updates are applicable to specific operating systems, firmware, applications, etc. and assessing their impact on system vulnerabilities has often been a manual and time-consuming process. Further, the manual process of determining the impact of vulnerabilities is error-prone and inefficient, especially large number of devices, applications, operating systems, and firmware.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2A is a flowchart illustrating one example of functionality implemented as portions of an application executed in a computing environment in the network environment of FIG. 1 according to various embodiments of the present disclosure.

FIG. 2B is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

FIG. 5A is a user interface diagram according to various embodiments of the present disclosure.

FIG. 5B is a user interface diagram according to various embodiments of the present disclosure.

FIG. 5C is a user interface diagram according to various embodiments of the present disclosure.

FIG. 5D is a user interface diagram according to various embodiments of the present disclosure.

FIG. 5E is a user interface diagram according to various embodiments of the present disclosure.

FIG. 6A is a user interface diagram according to various embodiments of the present disclosure.

FIG. 6B is a user interface diagram according to various embodiments of the present disclosure.

### DETAILED DESCRIPTION

Disclosed are various approaches for automatically managing vulnerabilities using a using a device management system and a unified endpoint management application. In some embodiments, CVE and CPE can be used to perform a reverse lookup to generate a vulnerability report. In some other embodiments, the vulnerability report can be used to generate a recommendation or remediation action.

Typically, an enterprise or organization works with multiple types of operating systems, multiple types of electronic devices, application, firmware, etc. The device management systems in the enterprise provide a means to collecting data about the multiple types of devices. The data can be used to determine which updates are available and which updates are applicable to the specific devices, operating systems, firmware, application, etc.

In some instances, the device management system can be used to assess the impact of vulnerabilities of the updates on a system. However, determining which updates are applicable to specific operating systems, firmware, devices, applications, etc. is typically a manual and time-consuming process/task.

Previously, one approach was to manually review a list of available updates provided by the device management system and cross-referencing the list of available updates with the device information to determine which updates are relevant to a specific device. This process can be error-prone, inefficient, and time-consuming, especially when dealing with a large number of different versions of applications, multiple types of operating systems and devices in an enterprise. Additionally, assessing the common vulnerabilities and exposures (CVE) associated with a common platform enumeration (CPE) requires extensive knowledge and research.

Next, another approach involves utilizing multiple vulnerability databases to identify and assess vulnerabilities. However, this requires manual input of information about individual devices, applications, firmware, operating systems, etc. This further lacks automation in determining applicable updates from the list of available updates. This approach also fails to generate a comprehensive vulnerability report. Similar to the approach above, it is a time-consuming and complex process that can be error-prone. Additionally, previous approaches often lack actionable recommendations or remediations actions, and/or a workflow to apply the updates.

In contrast, the approaches herein introduce an automated vulnerability management system using a device management system. Accordingly, embodiments of the present disclosure can identify, evaluate, process, and/or provide a remediation plan for one or more vulnerabilities. In some examples, the embodiments of the present disclosure can compare the common vulnerabilities and exposures (CVE) of a common platform enumeration (CPE), use the common vulnerability scoring system (CVSS) to generate a CVSS score to rank the CVE and assign a severity level, and generate a recommendation. In some examples, the embodiments of the present disclosure can manage the vulnerabilities associated with devices, applications, firmware, and/or operating systems using a unified endpoint management (UEM) application.

Upon collecting a list of available updates, the UEM application can query the device management system or the data collection service for information on the electronic device. The data collection service or the device management system can provide the data to the UEM from the device information stored in the data store. The UEM application can determine applicable updates from the list of available updates. The applicable updates are updates to devices, application, firmware, or operating system in use by a device in the enterprise. After determining the applicable updates, the UEM application can determine the CPE of the available updates and the current version of the operating system, firmware, or application. A reverse lookup in performed to find vulnerabilities associated with the CPE of the current version of the operating system, firmware, and/or application, and vulnerabilities associated with the applicable updates. The UEM application can compare the CVE of each CPE and generate a vulnerability report. The vulnerability can provide detailed/comprehensive information about the vulnerability and any impacted systems, devices, firmware, operating system, or applications.

In another embodiment of the present disclosure, the administrator application can receive a recommendation or a remediation account from the vulnerability management service. In some examples, the administrator application can receive a recommendation or remediation action based at least in part on the application data, vulnerability data, patch data, and/or security incident data. The recommendation can be a soft recommendation or a strong recommendation. The recommendation could also be an actionable workflow generated in draft mode for administrator review.

In another embodiment, the administrator can select one or more of the available updates for a electronic device. The electronic device could receive a notification alerting them on the scheduled update selected by the administrator. The user can review the notification, opt to install the updates now, or delay the installation of the updates.

The techniques described herein for the automated vulnerability management system provide a significant technical improvement by reducing database storage (e.g., storing new available and applicable updates, storing information in multiple databases regarding vulnerabilities, etc.) and reducing network bandwidth of computing resources (e.g., related to evaluating and processing vulnerability assessments). These techniques can also provide significant technical benefit such as streamlining device and/or enterprise security (e.g., single management application, comprehensive vulnerability reports, automating vulnerability detection, etc.) and reducing operation costs (e.g., fewer applications/systems for vulnerability detection/management, fewer personnel, less equipment, etc.).

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

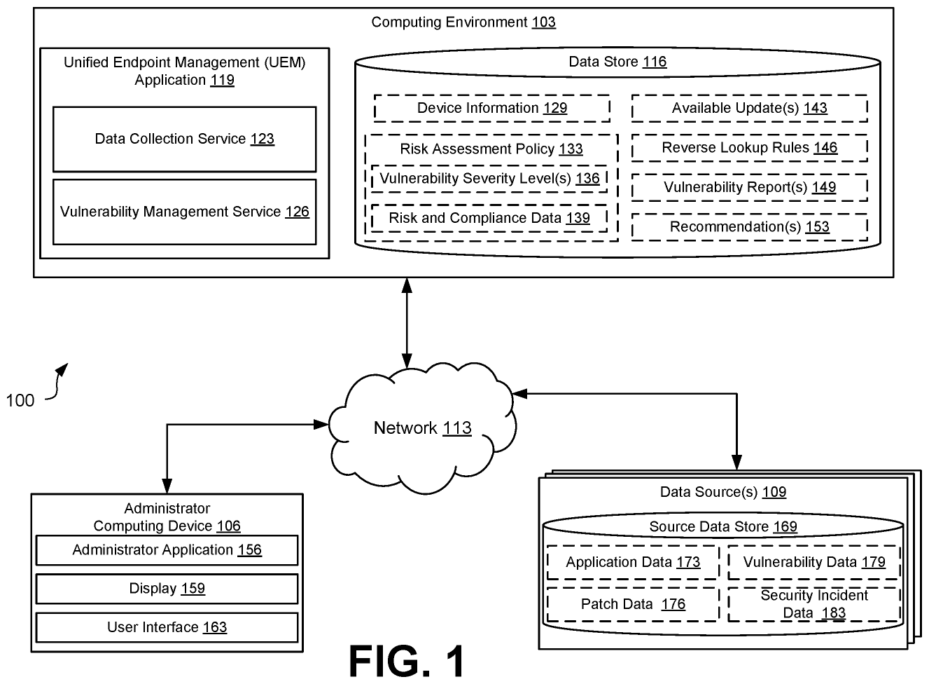

With reference to FIG. 1, shown is a networked environment 100 according to various embodiments. The networked environment 100 includes a computing environment 103, an administrator computing device 106, and data source(s) 109, which are in data communication with each other via a network 113.

The network 113 includes, for example, the Internet, one or more intranets, extranets, wide area networks (WANs), local area networks (LANs), wired networks, wireless networks, other suitable networks, or any combination of two or more such networks. For example, such networks may comprise satellite networks, cable networks, Ethernet networks, telephony networks, and other types of networks.

The computing environment 103 can be a computing environment that is operated by an enterprise, such as a business or another organization. The computing environment 103 can also include or be described as a management computing environment of a management service that is employed or utilized by an enterprise. The computing environment 103 includes a computing device, such as a server computer that provides computing capabilities. Alternatively, the computing environment 103 can employ multiple computing devices that are arranged in one or more server banks or computer banks, or other arrangements. In one example, the computing devices can be located in a single installation. In another example, the computing devices for the computing environment 103 can be distributed among multiple different geographical locations. In one case, the computing environment 103 includes multiple computing devices that together can form a hosted computing resource, a grid computing resource, and/or any other distributed computing arrangement. Additionally, the computing environment 103 can operate as an elastic computing resource where the allotted capacity of computing-related resources, such as processing resources, network resources, storage resources, or other computing-related resources can vary over time. In other examples, the computing environment 103 can include or be operated as one or more virtualized computer instances that can be executed to perform the functionality that is described herein.

Various systems and/or other functionality can be executed in the computing environment 103 according to various embodiments. Various applications can be executed in the computing environment 103. The components executed on the computing environment 103, for example, include a unified endpoint management (UEM) application 119, and other applications, services, processes, systems, engines, or functionality not discussed in detail herein. Moreover, the UEM application 119 can contain component applications such as a data collection service 123, a vulnerability management service 126, and other applications, services, processes, systems, engines, or functionality not discussed in detail herein, which can be executed by the computing environment 103.

Also, various data is stored in a data store 116 that is accessible to the computing environment 103. The data store 116 can be representative of a plurality of data stores 116, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 116, for example, is associated with the operation of the various applications and/or functional entities described below. The data stored in the data store 116 includes, for example, device information 129, a risk assessment policy 133, a list of available updates 143, reverse lookup rules 146, one or more vulnerability reports 149, one or more recommendations 153, and potentially other data. Moreover, the risk assessment policy 133 can contain data such as vulnerability severity levels 136, risk and compliance data 139, and potentially other data.

The device information 129 can include information such as the specifications, configurations, and status of electronic devices within the enterprise. The devices could be enterprise-issued devices or personal devices belonging to users employed by the enterprise. The device information 129 can also include information such as the make, model, operating system, applications, firmware version, networking configuration, and other relevant information about the device. In some embodiments, the device information 129 can be stored in the data store 116. In some other examples, the device information 129 can include past historical data regarding updates, patches, applications, vulnerabilities, etc. The past historical data can provide information for troubleshooting or generating device health reports. In some instances, the device information 129 can be used to determine applicability of the risk assessment policy 133, determine applicable updates from the list of available updates 143, generate a vulnerability report 149, and/or provide a recommendation 153.

The device information 129 could include data associated with a user account of the device, such as a clearance level, group and/or team information, and other user profile information. The device information 129 can include access settings, such as authentication credentials, delegation settings (e.g., information about other users who can be provided access to the device), mail and document retention rules and/or policies, and/or other geographic access restrictions or limitations (e.g., information about certain locations and/or networks from which the device can be accessed). The device information 129 can also include other account settings, such as biographical or demographic information about a user, password reset information, multi-factor authentication settings, and other data related to a user account as can be appreciated. In some embodiments, the device information 129 can be information about the hardware contained in the electronic device. For example, the device information 129 can represent information such as sensors, storage devices, networking devices, processors, memory, etc. In some other embodiments, the device information 129 can represent the installed software applications and/or the one or more operating systems. In some embodiments, the device information 129 can represent stored filed, usage history, the device state, and/or electronic device settings.

The device information 129 can include profile information about a user, authentication information about a user, and applications that are installed on a device associated with the enterprise. For example, the device information 129 can include information about enterprise resources to which a particular user has access, such as email, calendar data, documents, media, applications, network sites, or other resources. The device information 129 can also identify one or more user groups of which a particular user is a member, which can in turn define the access rights of the user to one or more enterprise resources as well as identify which applications should be deployed to one or more device(s) associated with the user.

The risk assessment policy 133 can include conditions, guidelines, and/or procedures for reinstalling and/or updating the software and/or hardware of the one or more electronic devices in the enterprise. In some cases, the risk assessment policy can apply to all of the electronic devices registered to the UEM application 119. In some embodiments, the risk assessment policy can encompass guidelines and/or parameters for evaluating one or more vulnerabilities. The risk assessment policy 133 could be used to categorize and determine the type for a vulnerability. In some embodiments, the risk assessment policy 133 could utilize the vulnerability severity levels 136 to determine how and when to apply the risk assessment policy 133 to one or more vulnerabilities. In some other embodiments, the risk assessment policy 133 can enact a systematic review of the vulnerability. The risk assessment policy could use the risk and compliance data 139 to require a device to adhere to the enterprise regulatory framework and/or internal data security guidelines. In other embodiments, the risk assessment policy 133 can determine when to deploy an update based at least in part on the vulnerability severity level 136 or the risk and compliance data 139. In another embodiment, the risk assessment policy 133 can be generated dynamically. In other examples, the risk assessment policy 133 can be generated dynamically based at least in part on the type of vulnerability. In some instances, the risk assessment policy 133 can be modified by the administrator application 156 and/or an administrator. In other examples, the UEM application 119 can modify the risk assessment policy 133.

The vulnerability severity levels 136 can be assigned based at least in part on a common vulnerability scoring system (CVSS). In some examples, the vulnerability severity levels 136 can be assigned based at least in part on a propriety metric. The CVSS is a method to supply a qualitative measure of severity. A CVSS score is also represented as a vector string, a compressed textual representation of the values used to derive the score. In some embodiments, the vulnerability severity levels 136 can be a low risk level, a medium risk level, a high risk level, or a critical risk level. The severity of the vulnerability is determined using a score of 0 to 10, where a score of 0.1-3.9 is assigned a low severity or low risk level, a score of 4.0-6.9 is assigned a medium severity or medium risk level, a score of 7.0-8.9 is assigned a high severity or high risk level, and a score of 9.0-10.0 is assigned a critical severity or critical risk level. The CVSS score can help an enterprise or organization assess and prioritize the vulnerability management process for a vulnerability based on the vulnerability severity level 136. In some examples, the CVSS score for a vulnerability can be obtained from the National Vulnerability Database (NVD). In some embodiments, the vulnerability severity levels 136 can be generated based at least in part on exploitability, impact, remediation cost, and severity scale.

The risk and compliance data 139 can include various information about datasets, benchmarks, and other enterprise standards for managing risks and vulnerabilities. The risk and compliance data 139 can include historical vulnerability management data, risk assessment matrices, and internal policies. In some examples, the risk and compliance data 139 could be used to generate the vulnerability report 149 and/or the recommendation 153.

The list of available updates 143 can represent a database or repository containing information on available patches, upgrades, firmware updates, or application updates for devices in the enterprise. The list of available updates 143 can be customized based at least in part on the device information 129. In some embodiments, the list of available updates 143 could be dynamically updated. The list of available updates 143 can be updated at custom or set time intervals (e.g., 1 hour, 1 day, 10 days, etc.). The list of available updates 143 can send a notification to an administrator of the UEM application 119 when a new update is available. In some instances, the list of available updates 143 can display one or more vulnerabilities mitigated in the current version or operating system.

The reverse lookup rules 146 can represent a set of rules that determine how vulnerabilities are traced and tracked. In some other instances, the reverse lookup rules 146 can determine where to look for information about vulnerabilities. In some embodiments, the reverse lookup rules 146 can determine the method to trace a vulnerability. In other embodiments, the reverse lookup rules 146 can determine when to perform a reverse lookup for a vulnerability for the current version and/or the available updates in the list of available updates 143.

The one or more vulnerability reports 149 can include comprehensive information on the one or more identified vulnerabilities. The vulnerability report 149 could include detailed documentation of the one or more vulnerabilities. In some embodiments, the vulnerability reports 149 can be customized to a user, a device, a operating system, an application, a firmware, and/or a combination of the aforementioned. The vulnerability report 149 can include impacted systems, devices, firmware, operating systems and/or applications. Additionally, the vulnerability report 149 can include mitigation measures/guidelines, vulnerability severity levels, and/or recommendations 153. In other instances, the vulnerability report can contain information on current operating system updates, security patches, applications, and settings/networking configurations.

The one or more recommendations 153 can represent a guide to resolve the vulnerabilities present on a device. In some embodiments, the one or more recommendations 153 can be based at least in part on the one or more vulnerability reports 149. The recommendation and/or remediation action could include recommendations/actions such as update(s) deployment, patch deployment, system/device quarantines, settings/configuration changes, or application removals. In some examples, the recommendation 153 can be modified by the UEM application 119. In other examples, the recommendation 153 can be modified by the administrator application 156. In some embodiments, the recommendation 153 can be a recommendation to install an application, a certificate, and/or a profile on the electronic device. In some examples, the one or more recommendations 153 can be generated based at least in part on the device information 129. In some embodiments, the recommendation 153 could flag the electronic device for maintenance. In some instances, the recommendation 153 can be a recommendation to adjust security standards, compliance standards based at least in part on the electronic device usage (e.g., meets HIPAA standards if used for health records or medical information, state related data privacy standards such as California Consumer Privacy Act, etc.), and performance standards (e.g., resource usage, memory usage, battery life, etc.).

The unified endpoint management application 119 can manage and/or oversee the operation of multiple devices that are enrolled within a device management framework. The UEM application 119 converges data management, security protocols, and vulnerability management into a consolidated, intuitive management application. The data collection service 123 could acquire, filter, and prepare a diverse dataset, enabling the UEM application 119 to form a foundational understanding of device statuses, updates, and potential vulnerabilities. The vulnerability management service 126 of the UEM application 119 can parse through datasets to identify, evaluate, and manage vulnerabilities in adherence to the defined risk assessment policy 133. The UEM application 119 can inform the administrator computing device 106 of the severity, implications, and remediation recommendations associated with one or more vulnerabilities. The UEM application 119 could automate update deployment, ensure end-to-end security, and compliance across the devices in the enterprise. Additionally, the UEM application 119 can facilitates device management policies, automated compliance checks, and vulnerability response mechanisms to ensure seamlessly integration. The UEM application 119 can help administrators safeguard the enterprise against potential threats and ensuring continual alignment with compliance and risk management frameworks.

For example, an employer may operate the UEM application 119 to ensure that the electronic devices of its employees are operating in compliance with various compliance policies. In other examples, the UEM application 119 may be operated to ensure that the operating system, firmware, and/or applications on the electronic devices are operating in compliance with various compliance rules. By ensuring that the client devices and/or the electronic devices are operated in compliance with the compliance rules, the enterprise could control and protect access to various data. The UEM application 119 may also facilitate access to email, calendar data, contact information, documents, or other enterprise data to which an enterprise may wish to provide access to users.

The data collection service 123 can automatically harvest and collect data from multiple devices. The data collected by the data collection service 123 can include data such as device specifications, device type, operating system version, installed applications/software, application/software update history, device usage, and current firmware. In some embodiments, the data collection service 123 can collect information from various databases, feeds, channels, etc. about vulnerabilities, patches, and security risks. In other embodiments, the data collection service 123 could communicate with internal and external databases and system to acquire the list of available updates 143 and vulnerabilities.

The data collection service 123 could contain a directory service that can serve as a network service that identifies, organizes, and process access to enterprise and/or organization resources. In some embodiments, the directory service may store information about the electronic devices, user accounts, access privileges, and other enterprise and/or organization related resources. The directory service can also manage user credentials that secure the electronic devices. In some instances, the directory service can be used to determine the identity of a device using the device-identifier. The directory service can use the device-identifier to assign and/or deploy the applicable updates of the available updates 143. In other instances, a directory service can be used to manage and provision the available updates 143. The directory service can further include role information within an organizational hierarchy. For example, a role can identify the user as an administrator for certain other users and/or as reporting to another user in an organization. The clearance level can specify one of a plurality of clearance levels.

The vulnerability management service 126 can manage the digital framework and the vulnerability mitigation operations. In some examples, the vulnerability management service 126 can retrieve a list of available updates 143 and/or request device information 129 from the device management system. Moreover, the vulnerability management service 126 can observe requests for vulnerability checks made through the administrator application 156. The vulnerability management service 126 can determine applicable updates for various devices, applications, operating systems, and firmware, and employ Common Platform Enumeration (CPE) for existing versions and available updates of those applications. The vulnerability management service 126 can send API requests to the data source(s) 109.

The vulnerability management service 126 can track the vulnerabilities associated with devices, operating systems, firmware, applications/software, etc. In other instances, the vulnerability management service 126 can manage one or more vulnerabilities and apply relevant updates or patches. For example, if a vulnerability is detected, the vulnerability management service 126 can send an email and/or a notification to the user and/or the administrator to alert about the potential risk. In some examples, the vulnerability management service 126 can alert the UEM application 119 and/or the administrator application 254 if the system encounters any issues (e.g., network issues, failure to retrieve updates, malfunction, etc.). Additionally, the vulnerability management service 126 can monitor the state of the vulnerabilities and modify the state upon mitigating the vulnerabilities. The vulnerability management service 126 can also deploy patches and/or update payloads. In some instances, the vulnerability management service 126 may be directed to deploy patches and/or update payloads by the administrator computing device 106 and/or the UEM application 119.

The administrator computing device 106 is representative of a plurality of client devices that can be coupled to the network 113. The administrator computing device 106 can comprise, for example, a processor-based system such as a computer system. Such a computer system can be embodied in the form of a desktop computer, a laptop computer, a personal digital assistant, a cellular telephone, a smartphone, a set-top box, a music player, a web pad, a tablet computer system, a game console, an electronic book reader, or any other device with like capability. In some embodiments, the administrator computing device 106 can represent a device that is owned or issued by the enterprise to a user, or a device that is owned by the user. In some embodiments, the administrator computing device 106, when provisioned, can be enrolled with the unified endpoint management application 119 as a managed device of the enterprise. The administrator computing device 106 can include a display 159a that comprises, for example, one or more devices such as liquid crystal display (LCD) displays, gas plasma-based flat panel displays, organic light emitting diode (OLED) displays, LCD projectors or other types of display devices.

The administrator computing device 106 can execute various applications, such as an administrator application 156 and/or other applications. In some embodiments, the administrator computing device 106 could represent a device executing a management component and/or a device that is enrolled within a device management framework associated with an enterprise. In some other embodiments, the administrator computing device 106 represents a device associated with a user who can be external to the enterprise or a device that is not enrolled within the device management framework of the enterprise. The administrator application 156 can include, for example, a browser, a dedicated application, or other executable, and the user interface 163a can include a network page, an application screen, or other user mechanism for obtaining user input. The administrator computing device 106 can be configured to execute applications beyond the administrator application 156 such as email applications, social networking applications, word processors, spreadsheets, or other applications. However, the administrator computing device 106 can be configured to operate in a “headless” configuration without a display 159a. In these configurations, the user interface 163a could be presented to another device over the network 113 (e.g., via the remote desktop protocol (RDP), secure shell (SSH) protocol, etc.).

The administrator application 156 can allow the administrator to manage at least one of the vulnerabilities, recommendations 153, remediations, or the draft workflows. In some examples, the administrator application 156 could allow the administrators to communicate with the electronic devices. In other examples, the administrator application 156 could allow the administrator to send an update to the electronic device enrolled in the UEM application 119. In other embodiments, the administrator application 156 could allow the administrator to send a payload file to the one or more electronic devices. In another embodiment, the administrator application 156 can be used to manage the available updates 143. In other instances, the administrator application 156 could be configured to execute or perform its functions without user intervention. For example, the administrator application 156 could be configured to use machine-learning, artificial intelligence, or similar approaches to perform its functions.

The data source(s) 109 are representative various databases, channels, and repositories that can be accessed by the computing environment 103. The data source(s) 109 can be extrinsic or intrinsic sources. The data source(s) 109 can be databases, cloud storage, web servers, API endpoints, or direct data feeds. The data source(s) can contain data such as vulnerabilities, exploits, patches, security incidents, security incident reports, security/vulnerability bulletins, and other similar data.

Various data is stored in a source data store 169 that is accessible in the data source(s) 109. The data stored in the source data store 169 is associated with the operation of the various applications or functional entities described below. This data can include application data 173, patch data 176, vulnerability data 179, security incident data 183, and potentially other data.

The application data 173 can be various data about application/software used by devices in the enterprise. The application data 173 can contain information such as version history, usage metrics, dependencies, metadata, and other relevant information. In some instances, the application data 173 can contain information for tracking and management of application lifecycles. In some other embodiments, the application data 173 can be used by the UEM application 119 to mitigate potential risks due to outdated or compromised applications.

The patch data 176 can be information regarding application/software patches and updates. The patch data 176 can include information such as patch description, version specifics, release notes, application CVE identifiers, and resolved vulnerabilities. In some embodiments, the patch data 176 can be used to generate a vulnerability report 149 or recommendations 153. In other embodiments, the patch data 176 can be collected by the data collection service 123 or the vulnerability management service 126 of the UEM application 119.

The vulnerability data 179 can contain information about known application vulnerabilities, operating system vulnerabilities, and firmware vulnerabilities. The vulnerability data 179 can contain detailed descriptions, impacted systems/devices, associated risks, and remediation methods. In some embodiments, the vulnerability data 176 can be used to generate a vulnerability report 149 or a recommendation 153.

The security incident data 183 can be a repository of reported or documented security incidents. The security incident data 183 can contain description of the event, impacted systems/devices, actions taken, and a timeline for resolution. The security incident data 183 can contain historical data about vulnerabilities that can be used to make an informed recommendation workflow. In other instances, the security incident data 183 can be used to generate a vulnerability report 149 or a recommendation 153.

Next, a general description of the operation of the various components of the networked environment 100 is provided. To begin, an enterprise, business, and/or organization can provide access to one or more electronic devices to the member of the enterprise, business, and/or organization. The member can be a user, an employee, a client, etc. The electronic devices can be offered through an IT team of the enterprise/organization or through a bring your own device. Information about the devices, whether enterprise owned, or employee/user owned can be collected through the data collection service 123 once the device is enrolled in the UEM application 119. The UEM application 119 can manage and/or oversee the operation of multiple devices that are enrolled within a device management framework of the UEM application 119. Additionally, the UEM application 119 can be a vulnerability management system to safeguard the digital infrastructure and data of the enterprise. The UEM application 119 can communicate with the administrator computing device 106 or data sources 109 to relay information, identify and inform of vulnerabilities impacting the enterprise or enterprise devices, and provide a recommendation 153 to mitigate the risks caused by the vulnerability. The data source(s) 109 can be channels, feeds, databases, repositories, or data sets containing information about applications, vulnerabilities, patches, security incidents, and other relevant information.

In order to automatically manage vulnerabilities, the UEM application 119 can collect a list of available updates 143 from data source(s) 109 or a device management system. In some instances, the list of available updates 143 are fetched at predetermined or custom time intervals. In other embodiments, the list of available updates 143 are fetched manually.

Then, the UEM application 119 can query the device information 129 or the data collection service 123 to obtain information on the one or more devices. The information can include device type, device information, device status, operating system, firmware, installed applications, and other relevant information. Once the device information 129 is obtained, the UEM application 119 can determine applicable updates for the devices from the list of available updates 143.

Then, the UEM application 119 can determine the CPE of the current version of operating system, applications, and firmware of a device. The UEM application 119 can also determine the CPE of the list of available updates 143. In order to save resources, the UEM application 119 could determine the CPE of only applicable updates from the list of available updates 143. The UEM application 119 can perform a first reverse lookup and a second reverse lookup to collect data about the CVE associated with the CPE. Once the data about the CVE is collected, the UEM application 119 can compare the CVE to generate a vulnerability report 149. The vulnerability report 149 can be used to generate a recommendation 153 or a remediation action. In some examples, the recommendation 153 can be a soft recommendation or a strong recommendation. In other instances, the recommendation can be an actionable workflow in draft mode for the administrator to review.

Then, the UEM application 119 can establish a secure connection with the device and send the package file or selected updates to be deployed and installed to the electronic administrator application 156 can also deploy the package file or selected updates to the one or more electronic devices. In some instances, the updates can be deployed via a wired (e.g., USB, ethernet, etc.) and/or a wireless connection (e.g., Wi-Fi-, Bluetooth, etc.). Once the connection is established between the UEM application 119 or the administrator application 156 and the electronic device, the updates can be deployed. The package file or updates can install the necessary files and configure the electronic device.

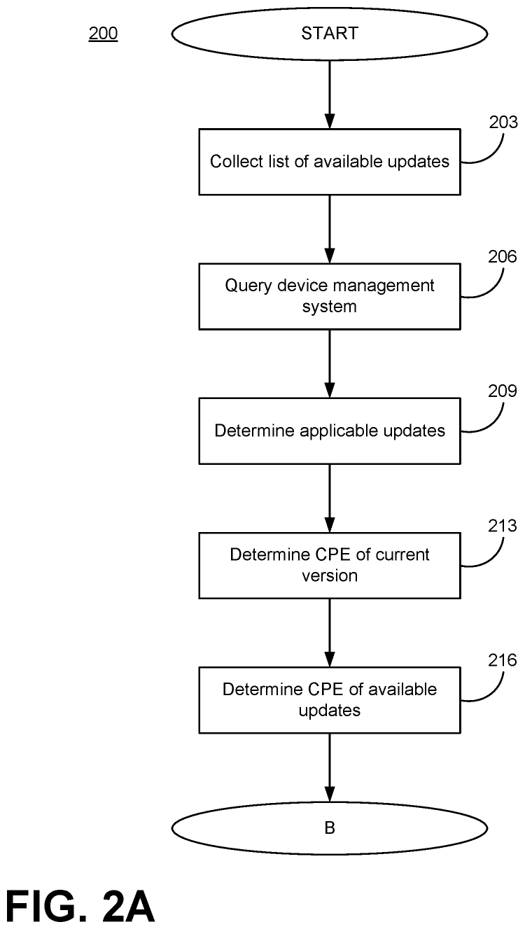

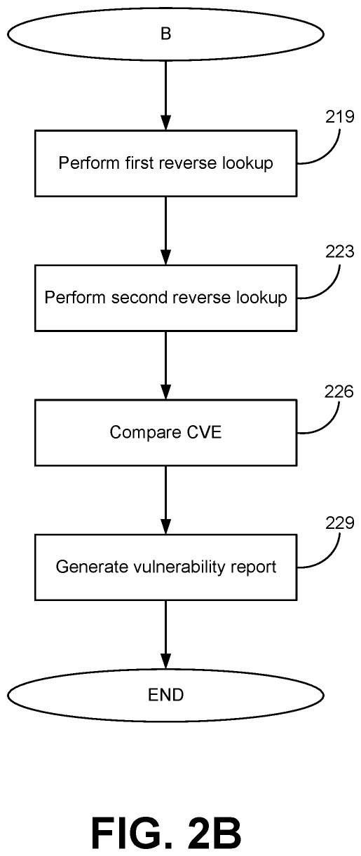

Referring next to FIGS. 2A and 2B, shown is a flowchart that provides one example of the operation of a portion of the UEM application 119 according to various embodiments. It is understood that the flowchart of FIGS. 2A and 2B provides merely an example of the many different types of functional arrangements that can be employed to implement the operation of the depicted portion of the UEM application 119 as described herein. As an alternative, the flowchart of FIGS. 2A and 2B can be viewed as depicting an example of elements of a method implemented in the computing environment 103 (FIG. 1) according to one or more embodiments.

Beginning with block 203, the vulnerability management service 126 of the unified endpoint management application 119 can collect a list of available updates 143. In some examples, the list of available updates 143 can be collected form a device management system. In other examples, the list of available updates 143 can be stored in the data store 116. The list of available updates 143 can be for operating systems, application, or firmware. In some embodiments, the list of available updates 143 can include patches and system upgrades. The available updates 143 can be procured from a variety of data source(s) 109.

At block 206, the vulnerability management service 126 of the unified endpoint management application 119 can query the device management system to obtain device information 129. In some instances, the vulnerability management service 126 can query the device management system to obtain information based at least in part on a custom query. The custom query can request information on devices with a specified operating system, application, or firmware. In some examples, the vulnerability management service 126 can request information for a specified device type. In some embodiments, the vulnerability management service 126 can perform a live query to collect the device information 129.

At block 209, the vulnerability management service 126 of the unified endpoint management application 119 can determine one or more applicable updates for the one or more applications based at least in part on the list of available updates 143. The determination of one or more applicable updates can be based at least in part on the current application version, operating system version, device compatibility, and other relevant factors.

At block 213, the vulnerability management service 126 of the unified endpoint management application 119 can determine a common platform enumeration of a current version of the one or more application. In some embodiments, the vulnerability management service 126 can categorize the system and applications to determine a CPE based on the categorization. In other embodiments, the vulnerability management service 126 can determine the versions and application details from the device information 129.

At block 216, the vulnerability management service 126 of the unified endpoint management application 119 can determine a common platform enumeration of one or more updates in the list of available updates 143. The vulnerability management service 126 can determine the CPE of the available updates 143 based at least in part on the metadata and versioning schema.

At block 219, the vulnerability management service 126 of the unified endpoint management application 119 can perform a first reverse lookup in the vulnerability database for the one or more CVE associated with the current version of the one or more applications on the electronic device. The vulnerability management service 126 can map the determined CPE against the vulnerability databased to determine any vulnerabilities associated with the operating system, application/software, and firmware.

At block 223, the vulnerability management service 126 of the unified endpoint management application 119 can perform a second reverse lookup in the vulnerability database for the one or more CVE associated with the one or more applicable updates for the one or more applications. The vulnerability management service 126 can map the CVE of the one or more available updates 143 to gather new vulnerabilities associated with the available updates 143.

At block 226, the vulnerability management service 126 of the unified endpoint management application 119 can compare the one or more CVE of the current version of the one or more applications with the one or more CVE of the one or more applicable updates of the one or more applications. The comparison of the CVEs of the current version and the available updates 143 can help in evaluating and generating a vulnerability report 149. In some embodiments, the comparison can be used to provide a recommendation 153.

At block 229, the vulnerability management service 126 of the unified endpoint management application 119 can generate a vulnerability report 149. The vulnerability report 149 can contain details of identified vulnerabilities, the impacts of the vulnerabilities, applicable updates, and mitigation measures/strategies. In some embodiments, the vulnerability report can provide a severity tag for individual ones of the one or more vulnerabilities.

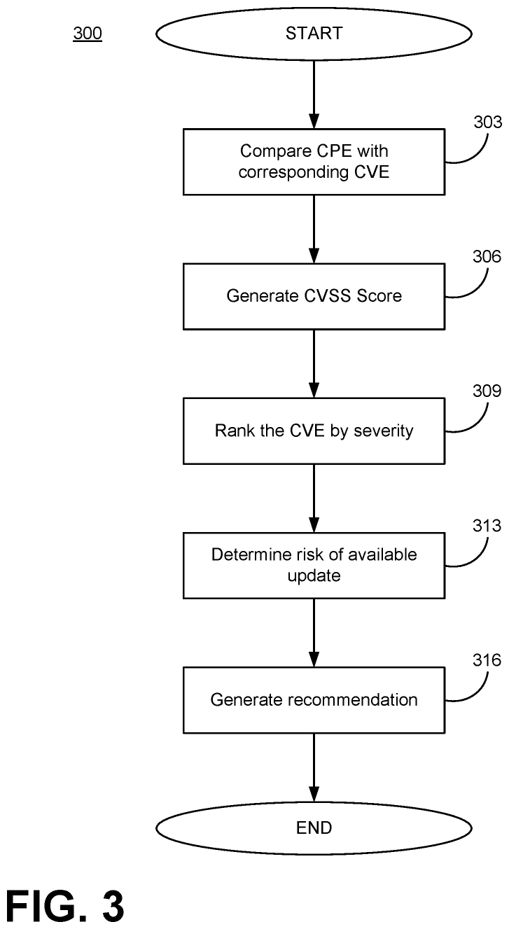

Referring next to FIG. 3, shown is a flowchart that provides one example of the operation of a portion of the UEM application 119 according to various embodiments. It is understood that the flowchart of FIG. 3 provides merely an example of the many different types of functional arrangements that can be employed to implement the operation of the depicted portion of the UEM application 119 as described herein. As an alternative, the flowchart of FIG. 3 can be viewed as depicting an example of elements of a method implemented in the computing environment 103 (FIG. 1) according to one or more embodiments.

Beginning at block 303, the vulnerability management service 126 of the unified endpoint management application 119 can compare the CPE of one or more applications with the corresponding CVE. The comparison allows for matching identified applications, operating systems, and firmware to be matched with any known vulnerabilities through the CVE of the CPE. The comparison results can be stored in the data store 116 or in the UEM application 119.

At block 306, the vulnerability management service 126 of the unified endpoint management application 119 can determine a CVSS score for the CVE. In some instances, the vulnerability management service 126 can generate the CVSS score for the CVE. In other embodiments, the vulnerability management service 126 can generate a score based at least in part on a proprietary metric. In some embodiments, the vulnerability management service 126 can generate the CVSS score based at least in part on a combination of scoring systems.

At block 309, the vulnerability management service 126 of the unified endpoint management application 119 can rank the CVE based at least in part on the CVSS score. In some examples, the vulnerability management service 126 can rank the CVEs based at least in part on the severity level. In other examples, the vulnerability management service 126 can rank the CVEs based at least in part on the risk assessment policy 133.

At block 313, the vulnerability management service 126 of the unified endpoint management application 119 can generate a CVSS score the CVE associates with CPE of the list of available updates 143. In some examples, the vulnerability management service 126 can rank the available updates 143 based at least in part on a severity level. In other examples, the vulnerability management service 126 can rank the list of available updates 143 based at least in part on the type and usage of the application, operating system, or firmware within the enterprise.

At block 316, the vulnerability management service 126 of the unified endpoint management application 119 can generate a recommendation 153. In some examples, the recommendation 153 can be a strong recommendation. In other examples, the recommendation 153 can be a soft recommendation. In some examples, the strong recommendation can be a recommendation to upgrade the application, operating system, or firmware. In some examples, the soft recommendation can be a recommendation to downgrade the application, operating system, or firmware.

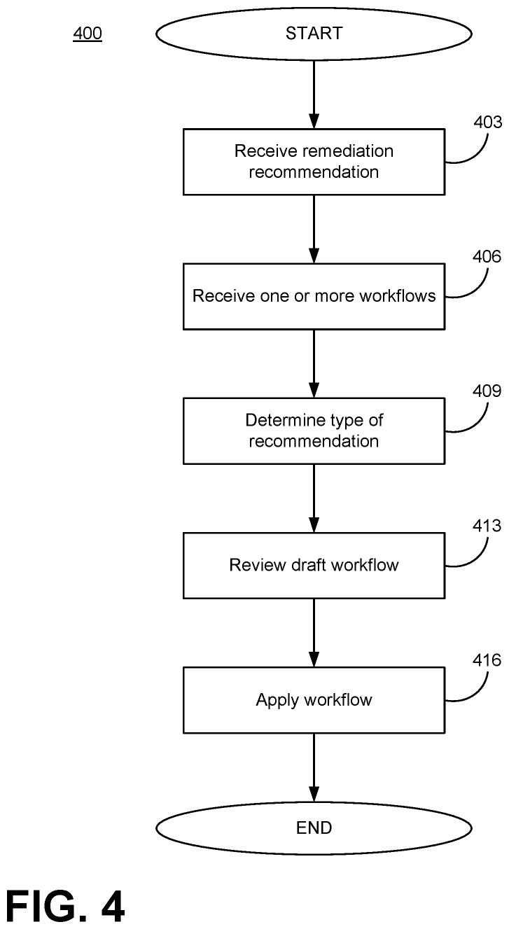

Referring next to FIG. 4, shown is a flowchart that provides one example of the operation of a portion of the administrator application 156 according to various embodiments. It is understood that the flowchart of FIG. 4 provides merely an example of the many different types of functional arrangements that can be employed to implement the operation of the depicted portion of the administrator application 156 as described herein. As an alternative, the flowchart of FIG. 4 can be viewed as depicting an example of elements of a method implemented on the administrator computing device 106 (FIG. 1) according to one or more embodiments.

Beginning at block 403, the administrator application 156 can receive a remediation action. In some examples, the administrator application 156 can receive a recommendation 153. In some examples, the recommendation 153 can be a strong recommendation. In other examples, the recommendation 153 can be a soft recommendation. In some examples, the strong recommendation can be a recommendation to upgrade the application, operating system, or firmware. In some examples, the soft recommendation can be a recommendation to downgrade the application, operating system, or firmware.

At block 406, the administrator application 156 can receive a workflow from the UEM application 119. In some examples, the workflow can be a step-by-step process or guide designed to implement the remediation or recommendation 153. In other examples, the workflow can be an actionable workflow pending administrator review. In some embodiments, the workflow can be detailed procedures to resolve vulnerabilities or mitigate risk of vulnerabilities. In some examples, the workflow can differ based at least in part on the device type, operating system, firmware, etc.

At block 409, the administrator application 156 can determine the recommendation is at least one a soft recommendation, strong recommendation. In some examples, the recommendation 153 can be a strong recommendation. In other examples, the recommendation 153 can be a soft recommendation. In some examples, the strong recommendation can be a recommendation to upgrade the application, operating system, or firmware. In some examples, the soft recommendation can be a recommendation to downgrade the application, operating system, or firmware. In some examples, a soft recommendation can imply a minimal impact on the enterprise and a strong recommendation can imply a critical/necessary action to avoid high-risk harm to the enterprise.

At block 413, the administrator application 156 can receive and review a draft workflow generated based at least in part on the recommendation 153. The draft workflow can be a preliminary procedural guide. In some instances, the draft workflow could leave out steps allowing an administrator to fill in the steps based at least in part on the risk assessment policy 133. In some examples, the draft workflow allows an administrator to validate the recommendation 153 or remediation action to align with the risk assessment policy 133.

At block 416, the administrator application 156 can apply the draft workflow to the devices in the UEM application 119. In some embodiments, the administrator can delete the draft workflow. In other embodiments, the administrator can modify the draft workflow and apply the draft workflow to the devices. In other examples, the draft workflow can be pre-validated to ensure compliance with the risk assessment policy 133 and compatibility with the device.

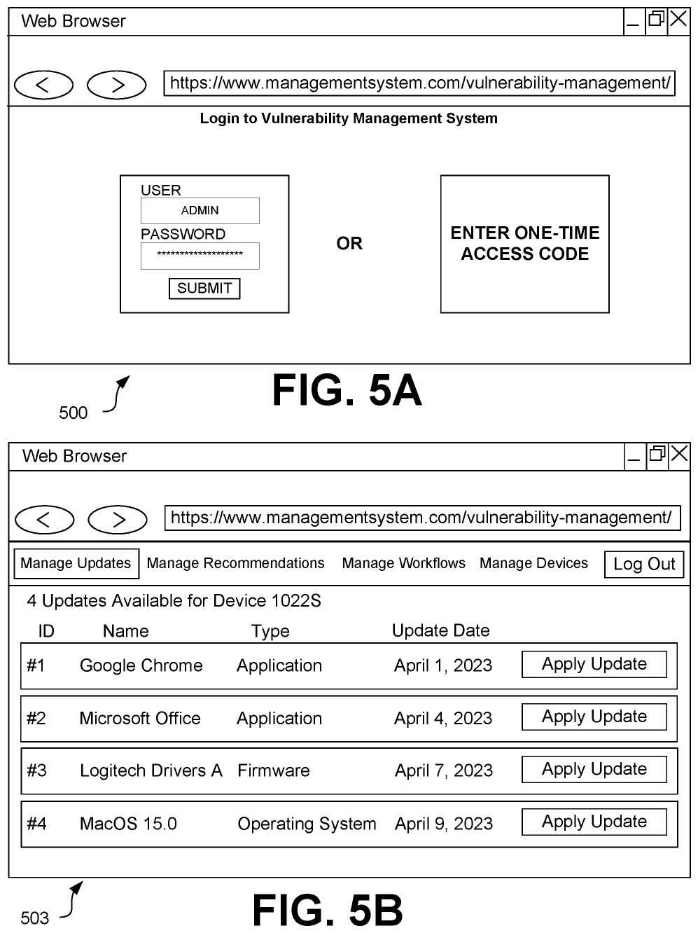

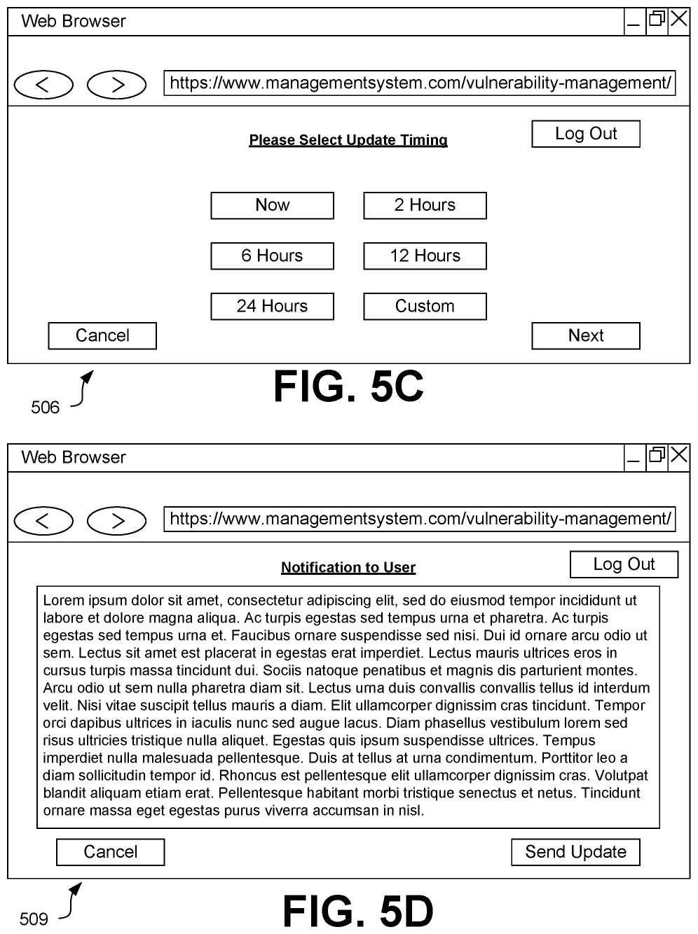

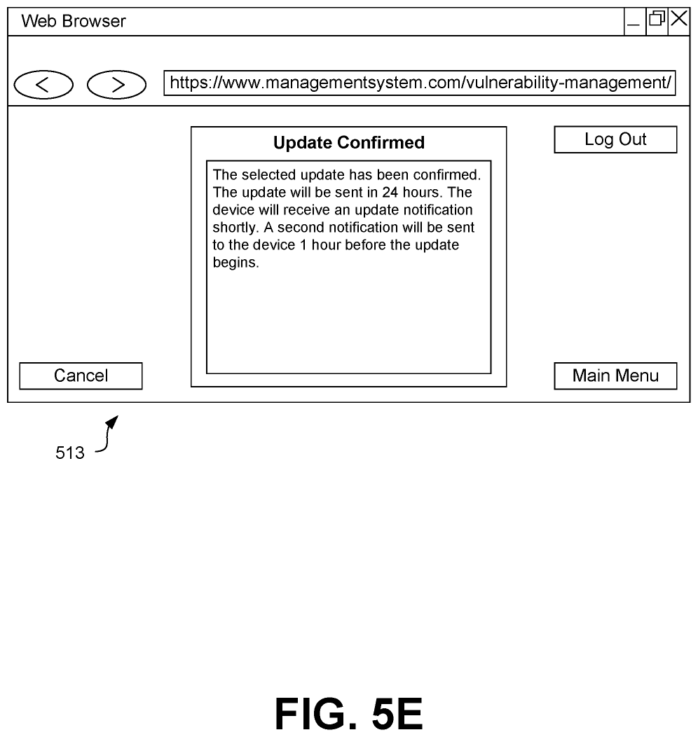

FIGS. 5A-5E depict various examples of scenarios where an administrator could manage the one or more vulnerabilities according to various embodiments of the present disclosure. In both of these examples, the administrator ser is able to login in on the administrator application 156 or a web browser to manage the one or more vulnerabilities. For example, the administrator could click “apply update” to send the update/update file to the selected device.

Referring to FIGS. 5A-5E, shown is a user interface diagram 500, 503, 506, 509, and 513, displayed on a display 159 (FIG. 1) of the administrator computing device 106 (FIG. 1). In some instances, the user interface 163 can be rendered on the display 159 by a web browser. In other instances, the user interface 163 can be rendered and displayed on a dedicated application, a mobile application, or other related environments. The user interface 163 represents an application to manage updates and vulnerabilities for the one or more electronic devices. The user interface 163 can be rendered by the administrator application 156 (FIG. 1).

With reference to FIG. 5A, the user interface diagram 500 provides affordances for the administrator to input credentials, (e.g., username and password, physical security key, etc.) to request the one or more electronic devices. The user interface of the web browser can be used to input the requested credentials. Once the credentials are entered, the user can click the “Submit” button to submit the credentials for authentication. In some examples, the credentials can be based at least in part on the directory service of the data collection service 123.

Continuing the example of FIG. 5A, reference is now made to FIG. 5B, which illustrates another example user interface 503 that can be rendered on the administrator device 106. The user interface 503 shown in FIG. 5B displays the one or more updates available for a “Device 1022S.” In some examples, the available updates 143 could have a CPE and a CVE. In other examples, the available updates 143 could be assigned an ID. In some examples, the updates will be labeled with name, type, and an update date. In some embodiments, the web browser or the administrator application 156 could represent availability of the updates in a table, list, and/or a visual form with check marks or other similar marks. For example, the user interface in FIG. 5B displays a list of available updated 143. The user interface in FIG. 5B also allows the administrator to apply the updates to the device by clicking the “Apply Update” button. The administrator can terminate the session by clicking the “Log Out” button. In some instances, clicking the “Log Out” button will redirect the user to the user interface of FIG. 5A.

Continuing the example of FIGS. 5A and 5B, reference is now made to FIG. 5C, which illustrates another example user interface 506 that can be rendered on the web browser or administrator application 156 on the administrator device 106. The user interface 506 shown in FIG. 5C displays a plurality of buttons representing the period of time for when the update should be applied. In some embodiments, the administrator can select the period of time from a list, a button selection, a table, or other similar method. In some embodiments, the user can input a custom time for applying the update. For example, if the administrator wanted to update the electronic device after 3 days, the administrator could specify the time period as 3 days. The administrator can cancel the request by clicking the “Cancel” button. In some examples, pressing the “Cancel” button can redirect the administrator to the main menu. In other examples, pressing the “Cancel” button can redirect the administrator to the previous page. In some examples, there could be a “Back” button to redirect the administrator to the previous page to make modifications to the selection of updates. The administrator can select the time period and press the “Next” button to proceed to the next step of sending the updates to the electronic device. The administrator can terminate the session by clicking the “Log Out” button. In some instances, clicking the “Log Out” button will redirect the user to the user interface of FIG. 5A.

Continuing the example of FIG. 5A-5C, reference is now made to FIG. 5D, which illustrates another example user interface 509 that can be rendered on the web browser or administrator application 156 on the administrator device 106. The user interface 509 shown in FIG. 5D displays the custom “Notification to User” when the update is sent to the device. The “Notification to User” can be a preset message by the enterprise. In some instances, the “Notification to User” could be modified by the administrator. The administrator can cancel the request by clicking the “Cancel” button. For example, the administrator can decide to delay the update by clicking the “Cancel” button which would cancel the request. In some examples, pressing the “Cancel” button can redirect the administrator to the main menu. In other examples, pressing the “Cancel” button can redirect the administrator to the previous page. In some examples, there could be a “Back” button to redirect the administrator to the previous page which could allow the administrator to make modifications to the update timing. The administrator can set the “Notification to User” message and press the “Send Update” button to proceed to the next step of sending the update to the electronic device. The administrator can terminate the session by clicking the “Log Out” button. In some instances, clicking the “Log Out” button will redirect the user to the user interface of FIG. 5A.

Continuing the example of FIG. 5A-5D, reference is now made to FIG. 5E, which illustrates another example user interface 513 that can be rendered on the web browser or administrator application 156. The user interface 513 shown in FIG. 5E displays a message. In some instances, the user interface 513 can display a notification. For example, the message, alert, and/or notification can inform the administrator that the update has been delivered. In some instances, the message, alert, and/or notification can further inform the administrator of the selected updates and update timing. In some embodiments, the message, alert, and/or notification can inform the administrator of the steps/workflow of the update. The administrator can cancel the request by clicking the “Cancel” button. In some examples, pressing the “Cancel” button can redirect the administrator to the main menu. In other examples, pressing the “Cancel” button can redirect the administrator to the previous page. In some examples, there could be a “Back” button to redirect the administrator to the previous page which could allow the administrator to make modifications. The administrator can terminate the session by clicking the “Log Out” button. In some instances, clicking the “Log Out” button will redirect the user to the user interface of FIG. 5A. The administrator can navigate to the user interface 503 displaying the main menu of the vulnerability management system by clicking the “Main Menu” button. In some instances, clicking the “Main Menu” button will redirect the user to the user interface of FIG. 5B.

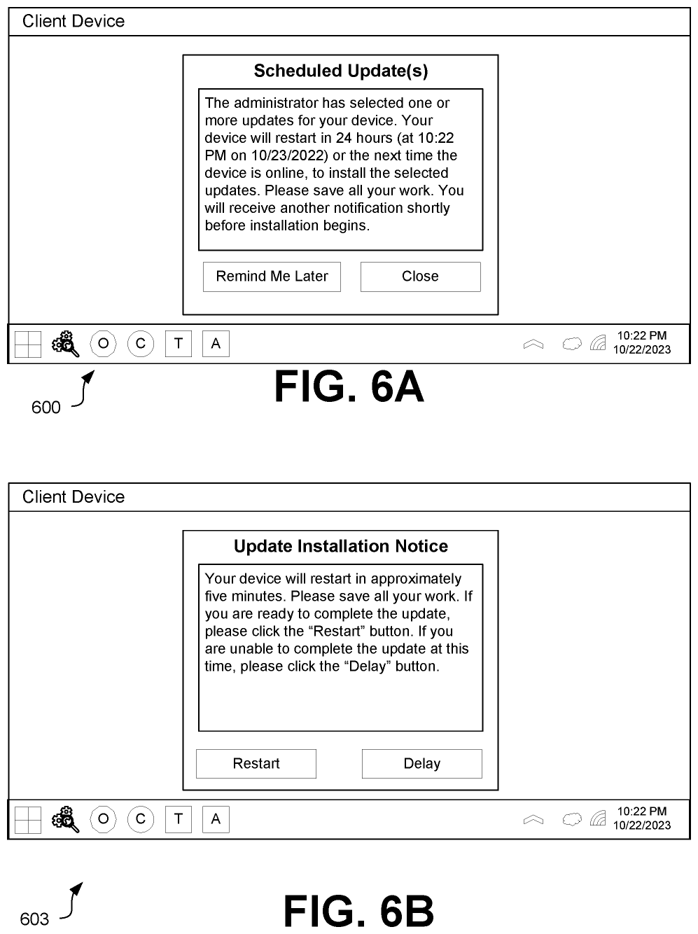

Referring to FIGS. 6A and 6B, shown is a user interface diagram 600 and 603, displayed on a display of a client device. In some instances, the user interface can be rendered on the display by a web browser. In other instances, the user interface can be rendered and displayed on a dedicated application, a mobile application, or other related environments. The user interface represents an application displaying a notice to a user of the device. The user interface can be rendered by the administrator application 156 (FIG. 1).

With reference to FIG. 6A, the user interface diagram 600 provides a notification for informing a user of scheduled update(s) for their electronic device. The user interface can present the notification by overlaying the notification on any active tasks or windows. Once the user has read the notification or wants to remove the notification, the user can click the “close” button to close and/or remove the notification. In some examples, the user can click the “remind me later” button and select a time for the system to generate the notification again at the selected time.

Continuing the example of FIG. 6A, reference is now made to FIG. 6B, which illustrates another example user interface 603 that can be rendered on the client device. The user interface 603 shown in FIG. 6B displays a second notification. In some embodiments, the user interface can display a list of updates along with the notification on the electronic device. In other examples, the user interface allows the user to select to install the updates now or to delay the installation of the updates. The administrator can delay the installation of the updates by clicking the “Delay” button. The user of the electronic device can install the updates by clicking the “Restart” button.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show an example of the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM), dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein may execute in the same computing device, administrator computing device 106, client device(s), or in multiple computing devices in the same computing environment 103. Additionally, it is understood that terms such as “application,” “service,” “system,” “engine,” “module,” and so on can be interchangeable and are not intended to be limiting.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It is emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
a set of machine-readable instructions stored in the memory that, when executed by the processor, cause the computing device to at least:
collect a list of available updates from a device management system;
query the device management system to obtain a plurality of device information on one or more devices;
determine one or more applicable updates for one or more applications based at least in part on the list of available updates;
determine a common platform enumeration (CPE) of a current version of the one or more applications;
determine the CPE of one or more updates in the list of available updates;
perform a first reverse lookup in a vulnerability database for one or more common vulnerabilities and exposures (CVE) associated with the current version of the one or more applications;
perform a second reverse lookup in the vulnerability database for the one or more CVE associated with the one or more applicable updates of the one or more applications;
compare the one or more CVE of the current version of the one or more applications with the one or more CVE of the one or more applicable updates of the one or more applications; and
generate a vulnerability report.

2. The system of claim 1, wherein the vulnerability report contains at least one of a risk level for the one or more CVE.

3. The system of claim 1, further comprising generating a recommendation, wherein the recommendation can be at least one of a soft recommendation or a strong recommendation.

4. The system of claim 1, further comprising providing at least one of a remediation action or a recommendation based at least in part on the vulnerability report.

5. The system of claim 1, further comprising generating one or more workflows in a draft mode for administrator review.

6. The system of claim 5, wherein the one or more workflows are based at least in part on a risk level for the one or more CVE.

7. The system of claim 1, wherein the plurality of device information further comprises at least one or more of:
endpoint device data;
operating system version;
application data;
device type; or
a software update history.

8. A non-transitory computer-readable medium comprising machine-readable instructions that, when executed by a processor of a computing device, cause the computing device to at least:
collect a list of available updates from a device management system;
query the device management system to obtain a plurality of device information of one or more devices;
determine one or more applicable updates for one or more applications based at least in part on the list of available updates;
determine a common platform enumeration (CPE) of a current version of the one or more applications;
determine the CPE of one or more updates in the list of available updates;
perform a first reverse lookup in a vulnerability database for one or more common vulnerabilities and exposures (CVE) associated with the current version of the one or more applications;
perform a second reverse lookup in the vulnerability database for the one or more CVE associated with the one or more applicable updates of the one or more applications;
compare the one or more CVE of the current version of the one or more applications with the one or more CVE of the one or more applicable updates of the one or more applications; and
generate a vulnerability report.

9. The non-transitory computer-readable medium of claim 8, wherein the vulnerability report contains at least one of a risk level for the one or more CVE.

10. The non-transitory computer-readable medium of claim 8, wherein the machine-readable instructions further cause the computing device to at least generate a recommendation, wherein the recommendation can be at least one of a soft recommendation or a strong recommendation.

11. The non-transitory computer-readable medium of claim 10, wherein the recommendation is an actionable workflow based at least in part on a risk level for the one or more CVE.

12. The non-transitory computer-readable medium of claim 8, wherein the machine-readable instructions further cause the computing device to at least generate one or more workflows in a draft mode for administrator review.

13. The non-transitory computer-readable medium of claim 12, wherein the machine-readable instructions further cause the computing device to allow an administrator to perform an action on the one or more workflows.

14. The non-transitory computer-readable medium of claim 8, wherein the machine-readable instructions further cause the computing device to at least employ a reverse lookup to correlate individual ones of a plurality of devices with the one or more CVE.

15. The non-transitory computer-readable medium of claim 8, wherein the machine-readable instructions further cause the computing device to provide a risk profile for at least one of an application, operating system, or a firmware.

16. A method, comprising:
collecting a list of available updates from a device management system;
querying the device management system to obtain a plurality of device information of one or more devices;
determining one or more applicable updates for one or more applications based at least in part on the list of available updates;
determining a common platform enumeration (CPE) of a current version of the one or more applications;
determining the CPE of one or more updates in the list of available updates;
performing a first reverse lookup in a vulnerability database for one or more common vulnerabilities and exposures (CVE) associated with the current version of the one or more applications;
performing a second reverse lookup in the vulnerability database for the one or more CVE associated with the one or more applicable updates of the one or more applications;
comparing the one or more CVE of the current version of the one or more applications with the one or more CVE of the one or more applicable updates of the one or more applications; and
generating a vulnerability report.

17. The method of claim 16, wherein the vulnerability report contains at least one of a risk level for the one or more CVE.

18. The method of claim 16, further comprising generating one or more workflows in a draft mode for administrator review.

19. The method of claim 18, further comprising allowing administrators to review and modify the one or more workflows.

20. The method of claim 18, wherein a recommendation is an actionable workflow based at least in part on a risk level for the one or more CVE.
